(19) United States
(12) Patent Application Publication
(10) Pub. No.: US 2009/0300489 A1
(43) Pub. Date: Dec. 3, 2009

(54) SELECTIVE ACCESS TO A FRAME BUFFER

(75) Inventors: Paul Mercer, Palo Alto, CA (US); Kevin Morgan, Santa Clara, CA (US)

Correspondence Address: RAUBVOGEL LAW OFFICE, 820 LAKEVIEW WAY, REDWOOD CITY, CA, 94062, US

(73) Assignee: PALM, INC., Sunnyvale, CA (US)

(21) Appl. No.: 12/132,498

(22) Filed: Jun. 3, 2008

(51) Int. Cl. G06F 3/14

(52) U.S. Cl. 715/273

(57) ABSTRACT

A method, system, and computer program display data by selectively providing access to a frame buffer. When a request for a destination location for display data is received, a determination is made as to whether the data will require further processing prior to display. If further processing is needed, a location of an external application buffer is provided. If no further processing is needed, a frame buffer is provided. Thus, improved efficiency is achieved, while still providing functionality for processing occlusions and/or composited sections of the display data.

### FIELD OF THE INVENTION

In various embodiments, the present invention relates to display of data in an electronic device, and more particularly to providing selective access to a frame buffer to improve efficiency and reduce artifacts.

### DESCRIPTION OF THE RELATED ART

It is well known to provide a buffer to store display data for display in a windowing system. A windowing system is a software system that permits application sharing of a display. One example of such a windowing system is a desktop comprising an electronic representation of a workspace in which windows are spawned for specific applications to display output.

A frame buffer is typically used by a windowing system to temporarily store display data used to render video displayed in a window. An application requests a location in memory to temporarily store its display data depending on a size and location of an associated window. The size and location can both be modified by user input from, for example, a user dragging a window across a desktop and resizing for a better view. Certain applications, such as video play-back applications or video games that are external to the display system, can be slow in adjusting how display data is stored in response to user interactions. Such applications often assume they have full and direct access to the frame buffer, and therefore are not aware of other considerations that may affect their display data as it is to be shown on the screen. Accordingly, display data from such applications may be written to a stale location or without regard to a new visual element layered on top, resulting in display artifacts. The display artifacts are visually undesirable.

In addition, direct access to the frame buffer can cause difficulties in handling occlusions and compositing. For example, if a visual element is dragged over the window, it may be necessary to occlude the window and/or composite it with the overlaying visual element. But if the application generating the window is given direct access to the frame buffer, it may erroneously write display data over space occupied by the visual element. In another example, when dragging a window, the application may continue to write display data over space that is no longer occupied by the window.

What is needed is a method to selectively redirect an application to an external frame buffer when such redirection is beneficial to properly handle occlusions and/or other interactions between a display window and other visual elements being displayed. In such situations, a windowing system can then perform separate processing before the final result is sent to the frame buffer. What is further needed is a method that takes advantage of improved efficiency that results from direct access to a frame buffer when no occlusions and/or interactions need to be processed.

### SUMMARY OF THE INVENTION

In various embodiments, a method, system, and computer program are provided for displaying data in a window or other display area by selectively providing access to a frame buffer. When a request for a destination location for display data is received, a determination is made as to whether the display data will require further processing prior to display. If further processing is needed, a location of an external application buffer is provided. If no further processing is needed, a frame buffer is provided. Thus, improved efficiency is achieved, while still providing functionality for processing occlusions and/or composited sections of the display data.

For example, in one embodiment a display window can be partially occluded (clipped) or composited with a visual element such as a menu, icon, or other window. However, when there is no overlapping in the display, the frame buffer can be used.

In one embodiment, advantageously, when further processing is needed, the application is not given direct access to the frame buffer, and the associated display data can be processed as needed. This reduces artifacts and ensures that compositing and/or occlusions are handled properly. Improved efficiency resulting from direct access to the frame buffer is maintained when such further processing is not needed.

### BRIEF DESCRIPTION OF THE DRAWINGS

The accompanying drawings illustrate several embodiments of the invention and, together with the description, serve to explain the principles of the invention. One skilled in the art will recognize that the particular embodiments illustrated in the drawings are merely exemplary, and are not intended to limit the scope of the present invention.

FIG. 1 depicts a system with a display module for displaying data in a display window, according to one embodiment.

FIG. 2 depicts a more detailed view of the display module of FIG. 1, according to one embodiment.

FIG. 3 is a flowchart depicting a method of displaying data in the display window with a selective processing step, according to one embodiment.

FIG. 4 is a flowchart depicting a method of selectively processing display data of with an overlap determination step, according to one embodiment.

FIG. 5 is a flowchart depicting a method of determining whether the display window overlaps a visual element, according to one embodiment.

FIGS. 6A and 6B depict examples of overlapping display windows, according to one embodiment.

FIGS. 6C and 6D depict examples non-overlapping display windows, according to one embodiment.

FIG. 7 is a flowchart depicting an overview of operation of the present invention according to one embodiment.

### DETAILED DESCRIPTION OF THE EMBODIMENTS

For purposes of the description provided herein, the following terms are defined as follows:

“Desktop” refers to an electronic workspace used to display windows and other visual elements such as menus and icons.

“Display window” (or “window”) refers to an on-screen area for displaying data. An example is a window used to display video from an external application or other types of graphics such as video game display, documents, and the like.

“Overlapping” refers to a display window that is intersects with another visual element in such a manner that requires occlusion and/or compositing.

“Non-overlapping” refers to a display window that does not intersect with another visual element, or that intersects with another visual element in a manner that does not require alteration of the display window's content (for example, if the display window is topmost and has no translucency).

“Frame buffer” refers to an area of memory that is used for receive display data for an output device.

“Application buffer” refers to another area of memory that is used by an application to receive display data.

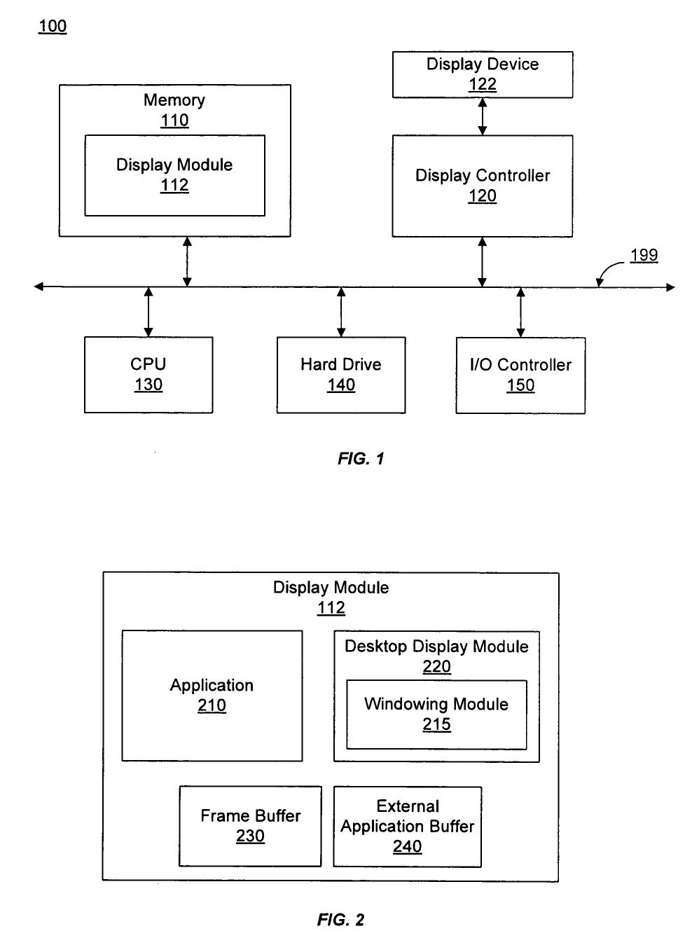

In FIG. 1, a window-based display system 100 window is shown, according to one embodiment. The system 100 comprises a memory 110, a display controller 120, a central processing unit (CPU) 130, a hard drive 140 and an I/O controller 150, each communicatively coupled through a bus 199. The memory 110 further comprises a display module 112. A display device 122 is communicatively coupled to the display controller 120. In one embodiment, the system 100 is implemented as a personal computer (PC) or portion thereof. In other embodiments, the system 100 comprises any type of processing system that displays video, such as a cell phone, television, handheld computer, personal digital assistant (PDA), or the like. The system 100, and individual modules such as the display module 112, can be centralized in a single device or distributed across several devices.

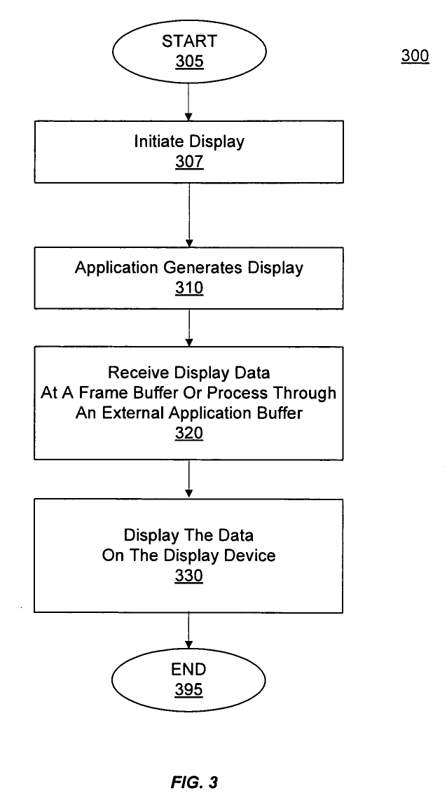

In one embodiment, the memory 110 receives data for display on display device 122. Such data can include, for example, video frames. Such display data can originate from within system 100 (e.g., stored on the hard drive 140) or from outside the system 100 (e.g., downloaded from the Internet or from an external device coupled to the I/O controller 150). The display module 112 processes the display data as described in more detail below with respect to FIG. 2. The CPU 130 performs general tasks related to executing applications stored in the memory 110. The display controller 120 can be a video graphics card and can perform video-specific tasks such as rending a desktop display, rendering output video, and the like. The display device 122 can be a computer monitor, a PDA display screen, or other mechanism for viewing a desktop.

Referring to FIG. 2, the display module 112 is shown in more detail, according to one embodiment. The display module 112 comprises an application 210 (such as a video application), a desktop display module 220, a frame buffer 230 and an external application buffer 240. The desktop display module 220 further comprises a windowing module 215. The components are grouped together as the display module 112 for the purpose of illustration only. In some embodiments, parts of the display module 112 can be implemented in hardware, or in software outside of the memory 110. For example, the frame buffer 230 and/or the external application buffer 240 can be located in the display controller 120. One skilled in the art will recognize that many other layouts and architectures are possible without departing from the essential characteristics of the invention.

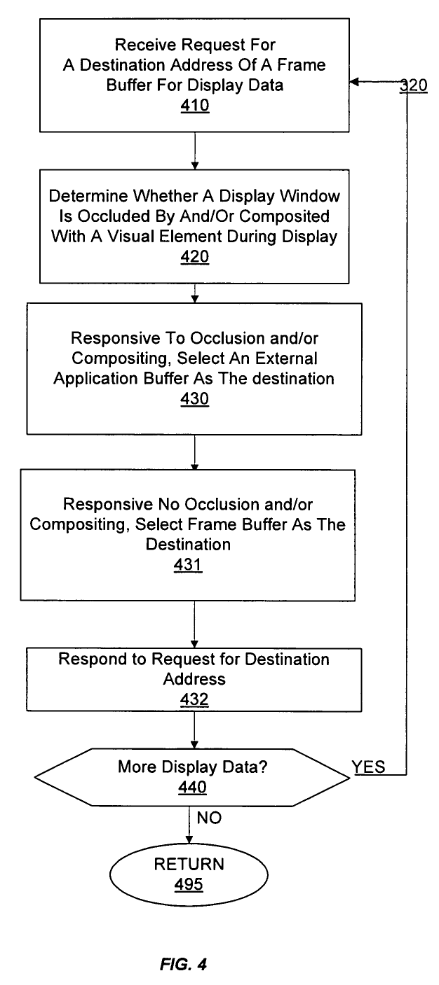

In various embodiments, the application 210 can be a third-party application, or an application that is integrated with an operating system. The desktop display module 220 manages the composition of a desktop and user interactions with visual elements such as windows, icons, and menus. The desktop display module 220 tasks a windowing module 215 to display applications within windows on a desktop. The windowing module 215 can spawn a new window to provide a contained environment for an application. Since several windows can be displayed on a desktop, along with other visual elements, there are times when the location of one window overlaps with the location of another window or visual element. As a result, the desktop display module 220 can selectively process display data based on whether there is overlap, on a frame-by-frame basis as described in more detail below with respect to FIG. 3.

The invention is described herein in the context of displaying visual elements in a desktop metaphor, as is common in many window-based user interfaces. However, one skilled in the art will recognize that this description is merely illustrative of a particular embodiment, and that the present invention can be implemented in other contexts as well.

The frame buffer 230 can be a single buffer or a collection of partitioned buffers (e.g., a buffer for each window, a buffer for each video frame, or the like). In one embodiment, buffers exists in RGB configuration in which a dedicated buffer for each video color of red, green, and blue. In another embodiment, one buffer receives an RGB frame and another buffer receives a YUV frame, and the frames are combined for output. The frame buffer 230 receives display data for the display device 122.

In one embodiment, as described in more detail below, the frame buffer 230 receives display data (such as frames of video) when the associated window does not overlap with other visual elements. Conversely, the external application buffer 240 receives display data when at least a portion of the associated window is overlapping, thus allowing for compositing or clipping prior to final display.

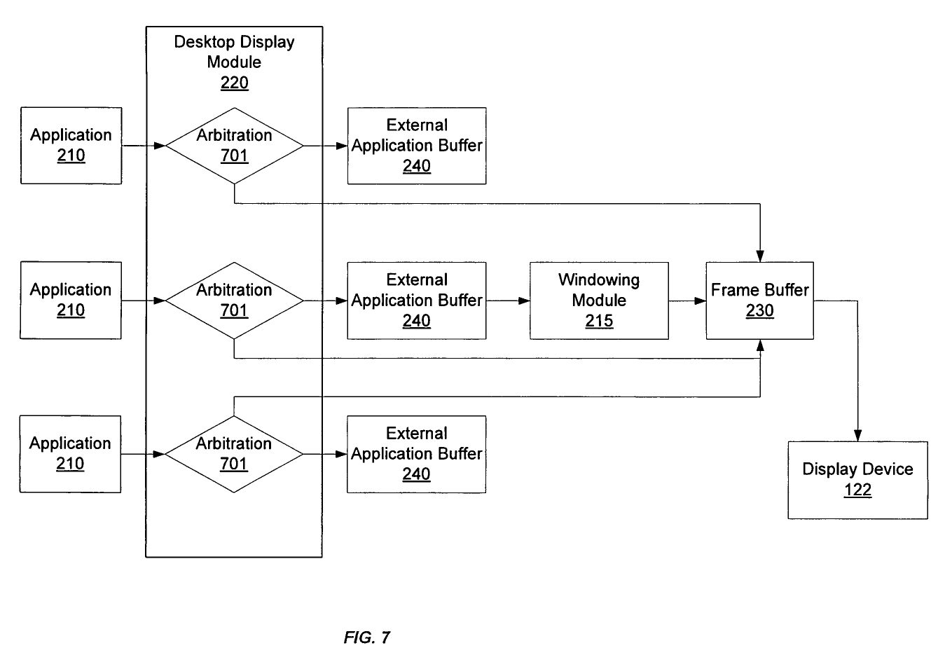

Referring now to FIG. 7, there is shown a flowchart depicting an overview of operation of the present invention according to one embodiment. The system of the present invention handles display data originating from any number of applications 210. For each frame of display data generated by an application 210, the desktop display module 220 (or other component) performs an arbitration 701 to determine whether the display data should be written to an external application buffer 240 or directly to the frame buffer 230. As described in more detail below, the desktop display module 220 selects the destination for the display data based on an analysis of occlusions, compositing requirements, and the like.

In one embodiment, the arbitration 701 takes place for each frame of display data generated by each application 210. In response to the application 210 requesting a destination for display, the system of the present invention provides a memory address representing either an external application buffer 240 or the frame buffer 230. In the example of FIG. 7, a separate external application buffer 240 is shown for each application 210. However, in other embodiments, fewer or more application buffers 240 can be provided.

In various embodiments, once the application 210 is given a memory address to use as a destination for display data, the application 210 writes its display data to the specified location. A windowing module 215 or other component performs compositing operations on data in the external application buffers 240 to generate composited data. The composited data is written to the frame buffer 230. The frame buffer 230 can therefore contain display data written directly by one or more applications 210, display data resulting from compositing operations 702, or any combination thereof. The contents of the frame buffer 230 are then output on the display device 122.

FIG. 3 is a flow chart depicting a method 300 for displaying data in a desktop window, according to one embodiment. Display is initiated 307. The application 210 generates display data, such as a frame of video data, for display within a display window on a desktop. In one embodiment, for each frame of data sent, the application 210 queries the desktop display module 220 for a destination to write display data. In response, the desktop display module 220 sends back a destination memory address, a format, and a geometric size of the display area.

In some cases, the desktop display module 220 provides a memory address corresponding to the external application buffer 240; in other cases, the desktop display module 220 provides the address of the frame buffer 230. In the latter case, either the entire frame buffer 230 or a portion thereof can be made available. In this manner, in step 320, the display data is either received at the frame buffer 230 or processed through the external application buffer 240, depending on whether compositing or occlusions are present.

More specifically, in some embodiments the destination address can be the frame buffer 230 when the display data does not require occlusion by or compositing with other visual elements. However, in the cases of occlusion or compositing, the destination address can be the external application buffer 240 so that further processing can take place before the display data is written to the frame buffer 230. The application 210 can store the destination address, where it can stay the same until the application 210 needs to write new display data. By preventing direct access to the frame buffer 230 when additional display processing is needed, the present invention in some embodiments ensures that the display data will be displayed properly including occlusions and/or compositing. By allowing direct access to the frame buffer 230 when no additional display processing is needed, the present invention provides improved efficiency when possible.

In one embodiment, the display window is displayed 330 on the display device 122. In one embodiment, this step includes displaying the data in a window of a user interface having a desktop metaphor. As discussed, the display module 112 and/or the display controller 120 perform various processing such as rendering, prior to output. The window size for containing displayed output can be allocated by the desktop display module 220.

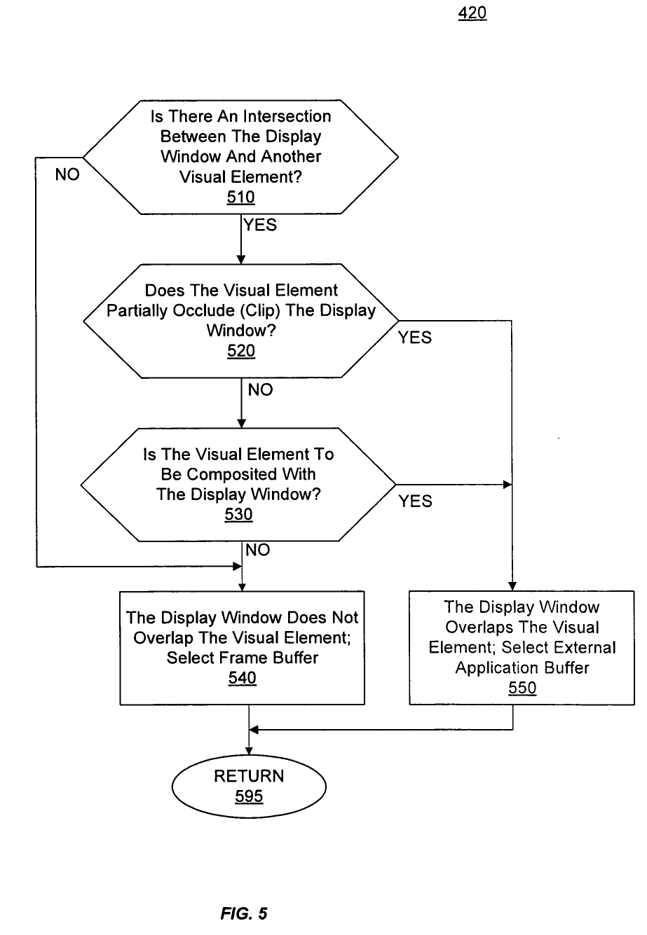

FIG. 4 is a detailed flow chart depicting one embodiment of a method 320 for selectively processing the display data through the external application buffer 240 or the frame buffer 230, according to one embodiment. In one embodiment, the steps of FIG. 4 are performed for each frame of display data originating from the application 210.

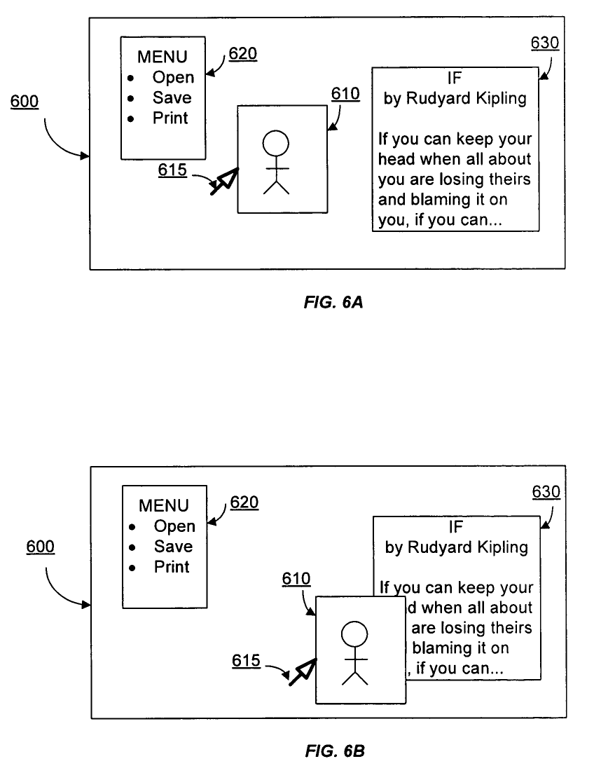

A request is received 410 for a destination address of the frame buffer 230 to write display data such as a video frame. A determination 420 is made as to whether a display area, such as a window, is occluded (at least partially) by a visual element during display, and/or whether the display window overlaps a visual element in a manner that requires compositing (for example if the visual element and/or the display window is/are to be rendered translucently). In making this determination, a desktop layout can be generated using the size and location of each window being displayed. Preferably, the determination 420 is made in a highly efficient manner so as to provide the functionality of the present invention without interrupting or affecting the display of data in a perceivable manner. Further details are described below with regards to FIG. 5.

Responsive to a display with occlusion and/or compositing, the external application buffer 240 is selected 430, so that the application 210 is not given access to the frame buffer 230. Rather, the display module 112 can control how the output video is displayed from the external application buffer 240. After the display module 112 properly renders the partially occluded (clipped) or composited display, in some embodiments, the resulting video data is then stored in the frame buffer 230.

If no occlusion and/or compositing is needed, the frame buffer 230 is selected 431.

The selected destination memory address is provided to the application 210 by a response 432 to the application's 210 request.

In step 440, the method repeats for each video frame or other quantum of display data.

FIG. 5 is a detailed flow chart depicting one embodiment of a method 420 for determining whether a display area (such as a display window) overlaps a visual element during display, according to one embodiment. At step 510, it is determined whether there is an intersection between the display window and another visual element.

If there is an intersection, it is determined whether the desktop either partially occludes (clips) the display window, in step 520, or whether the visual element is to be composited with the display window, in step 530 (for example, if either the visual element and/or the display window are to be displayed translucently). In one embodiment, occlusions and/or compositing can occur when at least a portion of a visual element and a display window each occupies the same pixel or segment.

If there is clipping or compositing, the display window overlaps the visual element 550, and an external application buffer 240 is selected. In one embodiment, the application 210 signals the display module 112 to indicate that it has completed writing data to the external application buffer 240, so that compositing or other processing can commence.

On the other hand, if there is neither clipping nor compositing, although there is an intersection, the display window does not overlap the visual element 540, and the frame buffer 230 is selected.

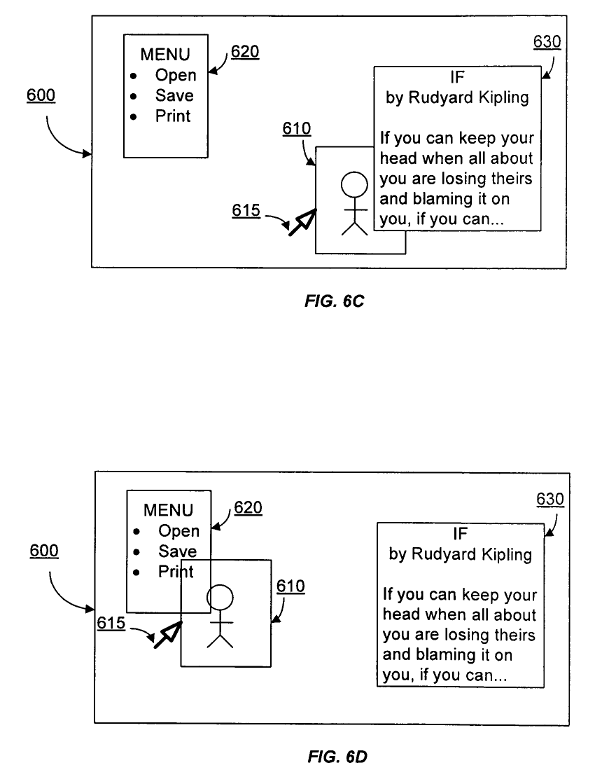

FIGS. 6A-B are schematic diagrams showing examples of non-overlapping display windows 610 and visual elements 620, 630, according to one embodiment. By contrast, FIGS. 6C-D are schematic diagrams showing examples of overlapping display windows 610 and visual elements 620, 630, according to one embodiment. More specifically, FIG. 6A illustrates a case of a display window 610 and visual elements 620,630 in which there is no intersection. Meanwhile, FIG. 6B illustrates an intersection between the display window 610 and the visual element 630 where the display window 610 is neither occluded (clipped) nor composited. In FIG. 6C the display window is partially occluded by the visual element 330, and in FIG. 6D, the display window 610 is composited with the visual element 620. Each of these cases would be handled according to the methods described above, so as to properly select either the frame buffer 230 (in the cases of FIGS. 6A and 6B) or an external application buffer 240 (in the cases of FIGS. 6C and 6D).

A desktop 600 can be displayed on devices as described herein. A user can interact with the desktop using any known input mechanism, including, for example, a mouse, a keyboard, a finger, a stylus, voice commands, and the like. In some cases, it may be useful to provide an on-screen cursor 615.

In one embodiment, the user can drag the display window 610 from one portion of the desktop 600 to another portion, as shown when comparing FIG. 6A to FIGS. 6B, 6C, and 6D. In one embodiment, when the cursor 615 drags the display window 610 across the desktop 600, the contents of the display window 610 move smoothly and with a reduced amount of artifacts, as a result of allowing selective access to the frame buffer 230.

Advantageously, by selectively redirecting the display data of the application 210 to the external application buffer 240 rather than the frame buffer 230, video artifacts can be reduced and improved performance can be achieved.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference herein to “one embodiment”, “an embodiment”, or to “one or more embodiments” means that a particular feature, structure, or characteristic described in connection with the embodiments is included in at least one embodiment of the invention. Further, it is noted that instances of the phrase “in one embodiment” herein are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Further, the computers referred to herein may include a single processor or may be architectures employing multiple processor designs for increased computing capability.

The algorithms and displays presented herein are not inherently related to any particular computer, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A method for displaying data, comprising:
receiving a request for a destination location for data to be displayed;
determining whether at least a portion of the data requires further processing prior to display; and
responsive to at least a portion of the data requiring further processing prior to display, responding to the request with an indication pointing to an application buffer for further processing prior to display;
receiving the data;
responsive to at least a portion of the data requiring further processing prior to display, processing the received data and transferring the processed data to the frame buffer; and
displaying contents of the frame buffer.

2. The method of claim 1, wherein:
determining whether at least a portion of the data requires further processing prior to display comprises determining whether at least a portion of a window is to be occluded by a visual element to be displayed; and
processing the received data comprises clipping the window according to the occlusion.

3. The method of claim 2, wherein:
determining whether at least a portion of the window is to be occluded by a visual element to be displayed comprises determining whether at least a portion of the visual element is to be displayed on top of at least a portion of the window.

4. The method of claim 2, wherein the visual element comprises one selected from the group consisting of:
a menu;
an icon; and
a window.

5. The method of claim 1, wherein:
determining whether at least a portion of the data requires further processing prior to display comprises determining whether at least a portion of a window is to be composited with a visual element to be displayed; and
processing the received data comprises compositing at least a portion of the window with at least a portion of the visual element.

6. The method of claim 5, wherein:
determining whether at least a portion of the window is to be composited with a visual element to be displayed comprises determining whether:
at least a portion of the window intersects at least a portion of the visual element; and
at least one of the window and the visual element is at least partially translucent.

7. The method of claim 5, wherein the visual element comprises one selected from the group consisting of:
a menu;
an icon; and
a window.

8. The method of claim 1, wherein receiving the data comprises receiving the data from at least one selected from the group consisting of:
a video display application;
a game application; and
a software application.

9. The method of claim 1, further comprising, prior to receiving the data:
responsive to no portion of the data requiring further processing prior to display, responding to the request with an indication pointing to the frame buffer.

10. The method of claim 1, wherein receiving the request for the destination location comprises receiving the request by a windowing system from an application.

11. A computer program product for displaying video in a window, comprising:
a computer-readable medium; and
computer program code, encoded on the medium, for:
receiving a request for a destination location for a data to be displayed;
determining whether at least a portion of the data requires further processing prior to display; and
responsive to at least a portion of the data requiring further processing prior to display, responding to the request with an indication pointing to an application buffer for further processing prior to display;
receiving the data; and
responsive to at least a portion of the data requiring further processing prior to display, processing the received data and transferring the processed data to the frame buffer; and
displaying contents of the frame buffer.

12. The computer program product of claim 11, wherein:
the computer program code for determining whether at least a portion of the data requires further processing prior to display comprises computer program code for determining whether at least a portion of a window is to be occluded by a visual element to be displayed; and
the computer program code for processing the received data comprises computer program code for clipping the window according to the occlusion.

13. The computer program product of claim 12, wherein:
the computer program code for determining whether at least a portion of the window is to be occluded by a visual element to be displayed comprises computer program code for determining whether at least a portion of the visual element is to be displayed on top of at least a portion of the window.

14. The computer program product of claim 11, wherein:
the computer program code for determining whether at least a portion of the data requires further processing prior to display comprises computer program code for determining whether at least a portion of a window is to be composited with a visual element to be displayed; and
the computer program code for processing the received data comprises computer program code for compositing at least a portion of the window with at least a portion of the visual element.

15. The computer program product of claim 14, wherein:
the computer program code for determining whether at least a portion of the window is to be composited with a visual element to be displayed comprises computer program code for determining whether:
at least a portion of the window intersects at least a portion of the visual element; and
at least one of the window and the visual element is at least partially translucent.

16. The computer program product of claim 11, wherein the computer program code for receiving the data comprises computer program code for receiving the data from at least one selected from the group consisting of:
a video application;
a video game application; and
a software application.

17. The computer program product of claim 11, further comprising computer program code for, prior to receiving the data:
responsive to no portion of the data requiring further processing prior to display, responding to the request with an indication pointing to a frame buffer.

18. The computer program product of claim 11, wherein the computer program code for receiving the request for the destination location comprises computer program code for receiving the request by a windowing system from an application.

19. A system for displaying data, comprising:
a frame buffer, for receiving a data that is ready for display in the window;
an application buffer, for receiving a data for further processing prior to display; and
a display module, for:
receiving a request for a destination location for data to be displayed; and
responsive to determining that at least a portion of the data requires further processing prior to display, responding to the request with an indication pointing to the application buffer for further processing prior to display;
a display processing component, for processing data in the application buffer and for transferring the processed data to the frame buffer; and
a display device, for displaying contents of the frame buffer.

20. The system of claim 19, wherein:
the display module determines whether at least a portion of the data requires further processing prior to display by determining whether at least a portion of a window is to be occluded by a visual element to be displayed; and
the display processing component processes the received data by clipping the window according to the occlusion.

21. The system of claim 20, wherein:
the display module determines whether at least a portion of the window is to be occluded by a visual element to be displayed by determining whether at least a portion of the visual element is to be displayed on top of at least a portion of the window.

22. The system of claim 19, wherein:
the display module determines whether at least a portion of the window requires further processing prior to display by determining whether at least a portion of a window is to be composited with a visual element to be displayed; and
the display processing component processes the received data by compositing at least a portion of the window with at least a portion of the visual element.

23. The system of claim 22, wherein:
the display module determines whether at least a portion of the window is to be composited with a visual element to be displayed by determining whether:
at least a portion of the window intersects at least a portion of the visual element; and
at least one of the window and the visual element is at least partially translucent.

24. The system of claim 19, wherein the frame buffer and the application buffer are adapted to receive the data from at least one selected from the group consisting of:
a video application;
a video game application; and
a software application.

25. The system of claim 19, wherein responsive to no portion of the data requiring further processing prior to display, the display module responds to the request with an indication pointing to a frame buffer.
